(19) United States
(12) Patent Application Publication
(10) Pub. No.: US 2005/0013442 A1
(43) Pub. Date: Jan. 20, 2005

(54) Sound field control system and sound field control method

(75) Inventor: Yoshiki Ohta, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/885,705

(22) Filed: Jul. 8, 2004

(30) Foreign Application Priority Data
Jul. 15, 2003 (JP) P. 2003-196844

(51) Int. Cl. H04R 5/02; H04R 5/00

(52) U.S. Cl. 381/1; 381/17

(57) ABSTRACT

A sound field control system measures impulse response in a playback sound field, calculates the binaural level difference expressed as the ratio between the ensemble mean values of signals to two detection sections installed at the positions corresponding to both ears, and sets the coefficient of the digital filter of a sound source correction section so that the error between the binaural level difference in a target sound field and the binaural level difference in the playback sound field becomes equal to or less than a predetermined value. The sound source correction section makes correction to an audio signal of a low frequency band so that the error between the binaural level difference in a target sound field and the binaural level difference in the playback sound field becomes equal to or less than the predetermined value.

### BACKGROUND OF THE INVENTION

1. Field of the Invention

This invention relates to a sound field control system and a sound field control method used for car audio, etc.

2. Description of the Related Art

In recent years, the audio listening environment has become diversified with the emergence of new audio media. Thus, there is a demand for a system which provides objective sound field space to provide a spatial impression simulating a concert hall, etc., in any listening environment. As such a system for providing the objective sound field space, for example, a system using an inverted filter such as a trans aural system is also proposed. (For example, refer to JP-A-2003-87899.) The trans aural system is a system intended for the listener to obtain presence as if the listener listens to sound in the objective sound space as the listener listens to sound recorded at the position of listener in the object sound space in the playback sound field.

More particularly, sound pressures PL and PR at external auditory meatus entrances of left and right ears obtained if the listener exists at the same position as a dummy head placed in the original sound field are matched with sound pressures SL and SR obtained as the original sound field is reproduced for the same listener in the playback sound field, and acoustic information collected in the original sound field is reproduced in the playback sound field. To realize the playback state, a playback equivalent filter called a crosstalk canceling filter is used to control the playback sound field.

JP-A-2003-87899 is referred to as a related art.

However, in the trans aural system of the related art, the characteristic of the playback sound field needs to be canceled through the inverted filter. Therefore, it is difficult to design in most real sound fields. For example, if a listener is a little distant from the optimum position, the listener obtains presence different from the original sound field, namely, the narrow control area is a problem. Particularly, to play back sound in a narrow space, control of strict localization of the original sound field, etc., is required and thus it is difficult to design an accurate inverted filter.

### SUMMARY OF THE INVENTION

An object of the invention is to provide a sound field control system and a sound field control method for making it possible to naturally reproducing a sound field space to be desired without giving a feeling of unnaturalness to a listener.

The invention provides a sound field control system, which generates a target sound field for an input signal, having a band dividing section for dividing the input signal into a plurality of frequency bands; and a sound source correction section for making correction to the input signal of a first frequency band provided by the band dividing section so as to eliminate the error between a first binaural level difference expressed as a ratio between ensemble mean values of signals to at least two detection sections in the target sound field and a second binaural level difference expressed as a ratio between ensemble mean values of signals to said two detection sections in a playback sound field.

The invention also provides a sound field control method of generating a target sound field for an input signal, having the steps of: dividing the input signal into a plurality of frequency bands; and making correction to the input signal of a divided frequency band so as to eliminate the error between a binaural level difference expressed as a ratio between ensemble mean values of signals to at least two detection sections in the target sound field and a binaural level difference expressed as a ratio between ensemble mean values of signals to said two detection sections in a playback sound field.

### BRIEF DESCRIPTION OF THE DRAWINGS

FIG. 1 is a schematic representation for explaining the principle of the invention;

FIG. 2 is a block diagram to show the configuration of a sound field control system according to an embodiment of the invention;

FIG. 3 is a flowchart to explain the sound field adjustment operation of the sound field control system in FIG. 2;

FIG. 4 is a drawing to show the configuration of a sound field control system of a first example;

FIG. 5 is a flowchart to explain the calculation operation of the binaural level difference in a target sound field;

FIG. 6 is a flowchart to explain the setting operation of the coefficients of digital filters of sound source correction sections;

FIG. 7 is a drawing to show a configuration example of the digital filter of the sound source correction section implemented as a FIR filter;

FIG. 8 is a schematic drawing to show FilL=[1, 0, 0, . . . ];

FIGS. 9A to 9E are drawings to describe the control image of coefficients FilL and FilR of digital filters FilterL and FilterR;

FIGS. 10A to 10D are schematic drawings to specifically describe the update method of the coefficients FilL and FilR of the digital filters FilterL and FilterR;

FIG. 11 is a drawing to show the configuration of a sound field control system of a second example;

FIG. 12 is a drawing to show the configuration of a sound field control system of a third example;

FIG. 13 is a drawing to show the configuration of a sound field control system of a fourth example;

FIG. 14 is a flowchart to explain the calculation operation of the binaural level difference in a target sound field in the sound field control system in FIG. 13; and

FIG. 15 is a flowchart to explain the setting operation of the coefficients of digital filters of sound source correction sections.

### DETAILED DESCRIPTION OF THE PREFERRED EMBODIMENTS

A preferred embodiment of a sound field control system and a sound field control method according to the invention will be described with reference to drawings.

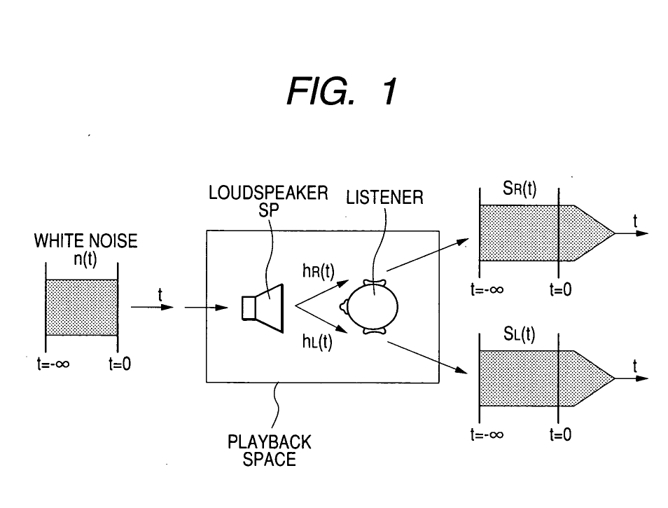

A sound field control system of an embodiment will be explained with reference to FIGS. 1 to 3. FIG. 1 is a schematic representation for explaining the principle of the invention. The binaural level difference when stationary white noise is applied to a loudspeaker SP can be uniquely calculated as impulse response to the binaural positions from the loudspeaker SP. The ensemble mean value of signals to each ear can be calculated by integrating impulse responses. The applicant pays attention to the fact that transient binaural level difference fluctuation in falling of sound largely affects the spatial impression. In the embodiment, the transient binaural level difference is expressed as the ratio between the ensemble mean values of signals to ears (=integration values of impulse responses of ears) for use as the scale for representing the spatial impression.

In the embodiment, a digital filter is set so as to eliminate the error between a binaural level difference expressed as the ratio between the ensemble mean values of signals to ears in the target sound field and a binaural level difference expressed as the ratio between the ensemble mean values of signals to ears in the playback sound field. Thus, the target sound field space is naturally reproduced for the listener without a feeling of unnaturalness. The target sound field refers to a sound field space to be desired (target sound field space) such as a concert hall, a stadium, etc. The playback sound field refers to a sound field space in which sound is actually played back. The term “ears” is used to mean at least two detection sections for detecting an impulse response in a predetermined sound field space. These at least two detection sections are installed at the positions corresponding to the positions of both ears.

The calculation method of the transient binaural level difference will be explained with reference to FIG. 1. In FIG. 1, it is assumed that white noise is produced for a long time from the loudspeaker SP. In this case, signals S_{L}(t) and S_{R}(t) entering both ears can be represented as in the following equations (1) and (2).
S_{L}(t)=∫_{-∞}⁰n(τ)·h_{L}(t−τ)dτ (1)
S_{R}(t)=∫_{-∞}⁰n(τ)·h_{R}(t−τ)dτ (2)

According to the above equations (1) and (2), the squares of the signals S_{L}(t) and S_{R}(t) entering both ears can be represented as in the following equations (3) and (4).
S_{L}²(t)=∫_{-∞}⁰∫−∞⁰n(τ)·n(θ)·h_{L}(t−τ)·h_{L}(t−θ)dτdθ (3)
S_{R}²(t)=∫_{-∞}⁰∫_{-∞}⁰n(τ)·n(θ)·h_{R}(t−τ)·h_{R}(t−θ)dτdθ (4)

Using the fact that the ensemble mean on both sides is <n(τ)n(θ)>=Nδ(τ−θ) according to the above equations (3) and (4), the following equations (5) and (6) can be derived.
<S_{L}²(t)>=N·∫ₜ^{∞}h_{L}²(x)dx (5)
<S_{R}²(t)>=N·∫ₜ^{∞}h_{R}²(x)dx (6)

According to the above equations (5) and (6), transient binaural level difference TRILD(t) can be defined as in the following equation (7). In the definition equation (7) of the transient binaural level difference, it is made possible to express the binaural level difference fluctuation in the process in which sound attenuates as impulse response. Therefore, as the impulse response is measured, it is made possible to calculate the binaural level difference.

$$TRILD ( t ) = \frac{〈 {S}_{L}^{2} ( t ) 〉}{〈 {S}_{R}^{2} ( t ) 〉} = \frac{{\int }_{t}^{∞} {h}_{L}^{2} ( x ) ⅆ x}{{\int }_{t}^{∞} {h}_{H}^{2} ( x ) ⅆ x} \qquad ( 7 )$$

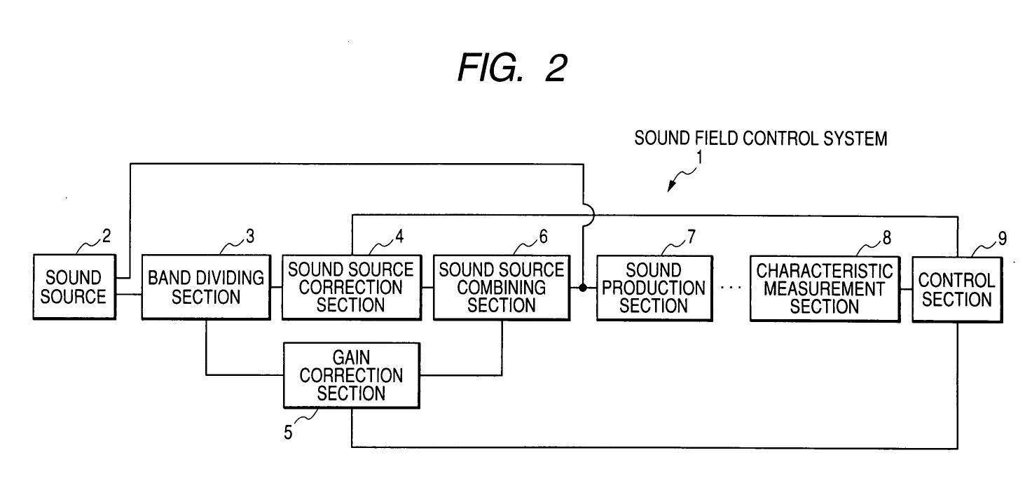

FIG. 2 is a block diagram to show the configuration of the sound field control system according to the embodiment. A Sound field control system 1 has a sound source 2, a band dividing section 3, a sound source correction section 4, a gain correction section 5, a sound source combining section 6, a sound production section 7, a characteristic measurement section 8, and a control section 9.

The sound source 2 supplies an audio signal to the band dividing section 3 in normal audio playback, and supplies an impulse response measurement signal (M series, TSP, etc.,) to the sound production section 7 in sound field adjustment described later.

The band dividing section 3 divides the input signal supplied from the sound source 2 into a plurality of frequency bands to supply the input signal of a first frequency band (for example, low frequency band) to the sound source correction section 4 and supply the input signal of a second frequency band (for example, medium to high frequency band) to the gain correction section 5.

The sound source correction section 4 is implemented as a digital filter. The coefficient of the digital filter can be adjusted by the control section 9. The sound source correction section 4 makes binaural correction to the input signal of the first frequency band supplied from the band dividing section 3 so as to eliminate the error between the binaural level difference in the target sound field and that in the playback sound field, and then supplies the signal to the sound source combining section 6.

The gain correction section 5 makes gain adjustment to the input signal of the second frequency band supplied from the band dividing section 3 to match the level of the signal with the level of the input signal corrected in the sound source correction section 4, and then supplies the signal to the sound source combining section 6. The gain of the gain correction section 5 can be adjusted by the control section 9.

The sound source combining section 6 recombines (adds) the corrected input signal supplied from the sound source correction section 4 and the high frequency component subjected to the gain adjustment supplied from the gain correction section 5, and then supplies the resultant signal to the sound production section 7. The sound production section 7 is implemented as a loudspeaker, for example, and produces sound of the input signal supplied from the sound source combining section 6.

The characteristic measurement section 8 measures impulse responses from the sound production section 7 to the binaural positions in the target sound field and the playback sound field at the sound source adjusting time. Then, the characteristic measurement section 8 calculates the binaural level differences in the target sound field and the playback sound field based on the measured impulse responses. In this case, the impulse response measurement signal output from the sound source 2 is passed through the band dividing section 3, the sound source correction section 4, and the gain correction section 5 and is produced as sound from the sound production section 7.

The control section 9 controls the sound source correction section 4 so as to eliminate the error between the binaural level difference in the target sound field and that in the playback sound field calculated by the characteristic measurement section 8. The control section 9 controls the gain of the gain correction section 5 to match the level of the input signal of the second frequency band divided in the band dividing section 3 with the level of the input signal of the first frequency band corrected in the sound source correction section 4.

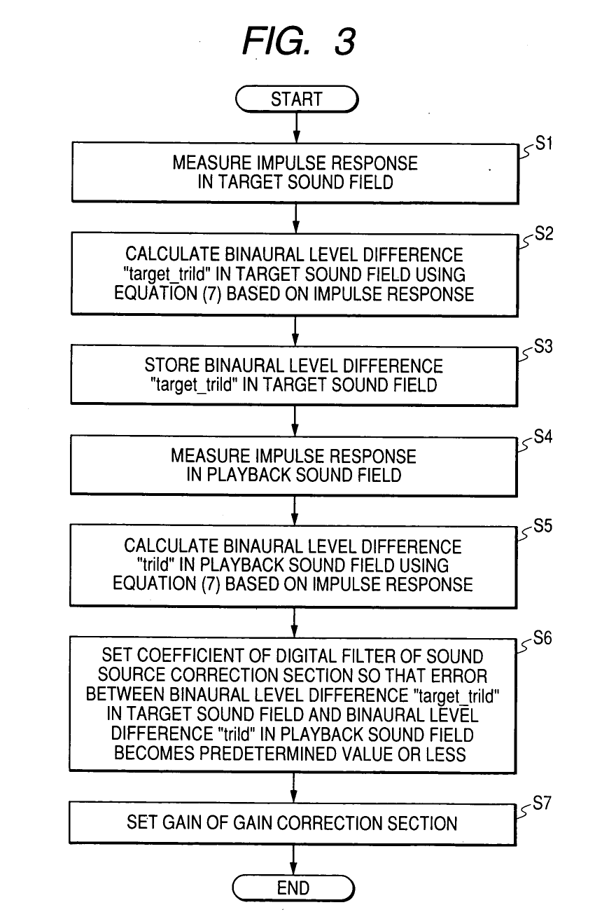

FIG. 3 is a flowchart to explain the operation of the sound field control system 1 in FIG. 2 at the sound field adjusting time. The sound field adjustment operation is executed when the user enters an execution command of sound field adjustment with a remote control (not shown), etc.

In FIG. 3, the characteristic measurement section 8 measures impulse response in the target sound field (step S1). The characteristic measurement section 8 calculates binaural level difference “target_trild” in the target sound field using equation (7) based on the measured impulse response (step S2). The control section 9 stores the calculated binaural level difference “target_trild” in the target sound field into a memory provided in the control section 9 (step S3).

Next, the characteristic measurement section 8 measures impulse response in the playback sound field (step S4). The characteristic measurement section 8 calculates binaural level difference “trild” in the playback sound field using equation (7) based on the measured impulse response (step S5). The control section 9 sets the coefficient of the digital filter of the sound source correction section 4 so that the error between the binaural level difference “target_trild” in the target sound field and the binaural level difference “trild” in the playback sound field becomes a predetermined value or less (step S6). Further, the control section 9 sets the gain of the gain correction section 5 to match the level of the input signal of the second frequency band divided in the band dividing section 3 with the level of the input signal of the first frequency band corrected in the sound source correction section 4 (step S7).

According to the embodiment, the band dividing section 3 divides the input signal into a plurality of frequency bands, and the sound source correction section 4 makes correction to the input signal of the first frequency band divided by the band dividing section 3 so as to eliminate the error between the binaural level difference expressed as the ratio between the ensemble mean values of the signals to the ears in the target sound field and the binaural level difference expressed as the ratio between the ensemble mean values of the signals to the ears in the playback sound field. As a result, when an audio signal input from the sound source 2 is produced as sound from the sound production section 7, it is made possible to naturally reproduce the target sound field space for the listener without a feeling of unnaturalness.

In addition, the sound source correction section 4 controls only the binaural parameter relating to the spatial impression, and filters only the low frequency component of the input signal. As a result, the effect of natural sound field reproduction with extremely less degradation of the sound quality can be produced. In the embodiment, a reliably stable approximate filter can be designed as compared with the method of completely matching impulse responses through an inverted filter as in the trans aural system. Further, since the sound source correction section 4 processes only the low frequency component of the input signal, a large-scaled system is not required and coexistence with other effects (reverberating, equalizing, etc.,) is also facilitated (see third example described below).

The control section 9 sets the coefficient of the digital filter of the sound source correction section 4 so that the error between the binaural level difference “target_trild” in the target sound field and the binaural level difference “trild” in the playback sound field becomes the predetermined value or less. As a result, it is made possible to naturally reproduce the target sound field space for the listener without a feeling of unnaturalness according to the simple method and configuration.

The gain correction section 5 makes gain adjustment to the input signal of the medium to high frequency band supplied from the band dividing section 3 to match the level of the signal with the level of the input signal corrected by the sound source correction section 4. As a result, it is made possible to strike a balance between low and high frequency components of the input signal.

### FIRST EXAMPLE

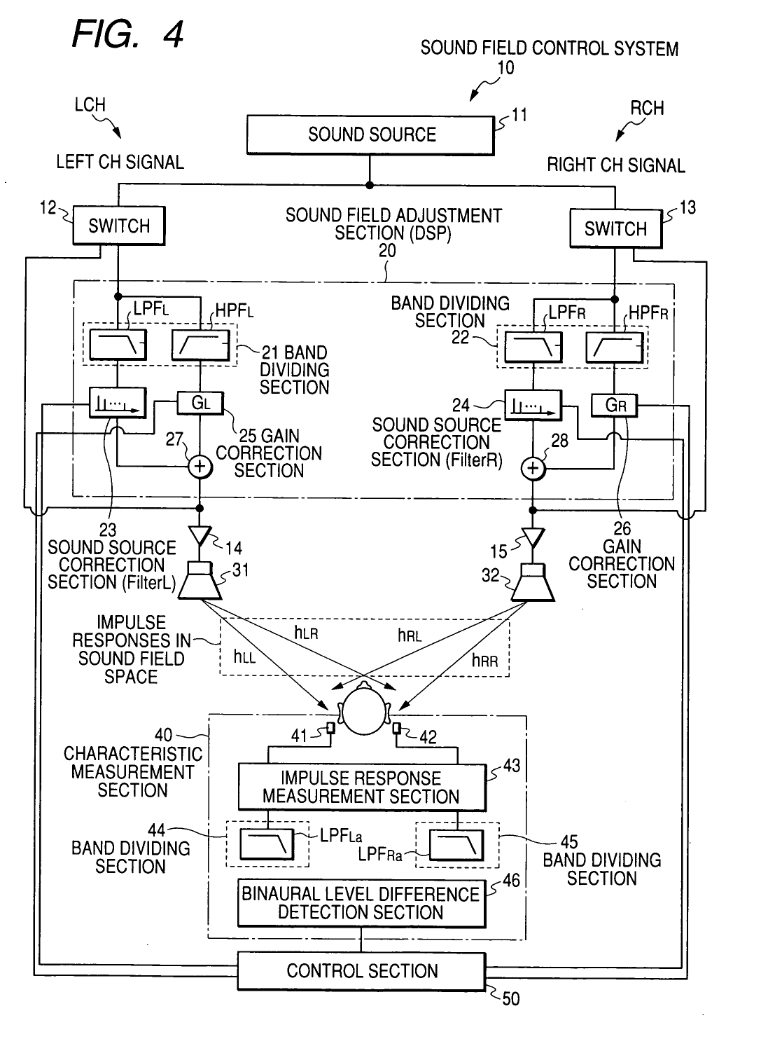

FIG. 4 is a drawing to show the configuration of a sound field control system 10 of a first example. The sound field control system 10 of the first example can process audio signals of a left channel and a right channel. The sound field control system 10 has a sound source 11, switches 12 and 13, a sound field adjustment section 20, amplifiers 14 and 15, loudspeakers 31 and 32, a characteristic measurement section 40, and a control section 50, as shown in FIG. 4. The sound source 11 supplies audio signals (digital signals) of a left channel and a right channel. The switches 12 and 13 direct the signals input from the sound source 11 into output destinations. The sound field adjustment section 20 adjusts the sound fields of the audio signals of the left and right channels input through the switches 12 and 13 from the sound source 11. The amplifiers 14 and 15 amplify the audio signals of the left and right channels input from the sound field adjustment section 20. The loudspeakers 31 and 32 produces sounds of the audio signals of the left and right channels amplified by the amplifiers 14 and 15. The characteristic measurement section 40 measures impulse responses in the target sound field and the playback sound field and calculating the binaural level differences in the target sound field and the playback sound field. The control section 50 controls the sound field adjustment section 20 based on the binaural level differences in the target sound field and the playback sound field detected by the characteristic measurement section 40.

The sound source 11 supplies audio signals to the sound field adjustment section 20 through the switches 12 and 13 in normal audio playback, and supplies impulse response measurement signals to the amplifiers 14 and 15 through the switches 12 and 13 in sound field adjustment described later. The switch 12 supplies the audio signal supplied from the sound source 11 to a band dividing section 21 of the sound field adjustment section 20, and supplies the impulse response measurement signal supplied from the sound source 11 to the amplifier 14 by bypassing the sound field adjustment section 20. Like the switch 12, the switch 13 supplies the audio signal supplied from the sound source 11 to a band dividing section 22 of the sound field adjustment section 20, and supplies the impulse response measurement signal supplied from the sound source 11 to the amplifier 15 by bypassing the sound field adjustment section 20.

The sound field adjustment section 20 is implemented as a digital signal processor (DSP). The sound field adjustment section 20 is made up of the band dividing sections 21 and 22 for the left and right channels for dividing bands of the audio signals of the left and right channels supplied through the switches 12 and 13 from the sound source 11, sound source correction sections 23 and 24 for the left and right channels for making binaural correction to the audio signals in low frequency band provided by the band dividing sections 21 and 22, gain correction sections 25 and 26 for the left and right channels for making gain correction to the audio signals in medium to high frequency band provided by the band dividing sections 21 and 22, and adders 27 and 28 for the left and right channels for adding outputs of the sound source correction sections 23 and 24 and outputs of the gain correction sections 25 and 26 together.

The band dividing section 21 includes a low-pass filter LPF_{L} and a high-pass filter HPF_{L} to which the LCH audio signal is supplied through the switch 12. The low-pass filter LPF_{L} allows a signal of 500 Hz or less, for example, to pass through and the high-pass filter HPFL allows a signal of 500 Hz or more, for example, to pass through. The low-pass filter LPF_{L} supplies the low frequency component of the LCH audio signal to the sound source correction section 23, and the high-pass filter HPFL supplies the medium to high frequency component of the LCH audio signal to the gain correction section 25.

Like the band dividing section 21, the band dividing section 22 includes a low-pass filter LPF_{R} and a high-pass filter HPFR to which the RCH audio signal is supplied through the switch 13. The low-pass filter LPF_{R} allows a signal of 500 Hz or less, for example, to pass through and the high-pass filter HPFR allows a signal of 500 Hz or more, for example, to pass through. The low-pass filter LPF_{R} is set to the same divide band as the low-pass filter LPF_{L}, and the high-pass filter HPFR is set to the same divide band as the high-pass filter HPFL. The low-pass filter LPF_{R} supplies the low frequency component of the RCH audio signal to the sound source correction section 24, and the high-pass filter HPFR supplies the medium to high frequency component of the RCH audio signal to the gain correction section 26.

The sound source correction section 23 is implemented as a digital filter FilterL for making binaural correction to the audio signal input from the low-pass filter LPF_{L} and supplying the signal. A coefficient FilL of the digital filter FilterL can be variably adjusted under the control of the control section 50 described later.

Like the sound source correction section 23, the sound source correction section 24 is implemented as a digital filter FilterR for making binaural correction to the audio signal input from the low-pass filter LPF_{R} and supplying the signal. A coefficient FilR of the digital filter FilterR can be variably adjusted under the control of the control section 50 described later.

The gain correction section 25, which is implemented as a gain controller G_{L}, makes gain adjustment to the audio signal of the medium to high frequency component input through the high-pass filter HPF_{L} and supplies the signal. The gain of the gain controller G_{L} can be adjusted under the control of the control section 50 described later.

Like the gain correction section 25, the gain correction section 26, which is implemented as a gain controller G_{R}, makes gain adjustment to the audio signal of the medium to high frequency component input through the high-pass filter HPFR and supplies the signal. The gain of the gain controller G_{R} can be adjusted under the control of the control section 50 described later.

The adder 27 adds the audio signal supplied from the sound source correction section 23 and the audio signal supplied from the gain controller GL of the gain correction section 25 together and supplies the resultant audio signal to the amplifier 14.

Like the adder 27, the adder 28 adds the audio signal supplied from the sound source correction section 24 and the audio signal supplied from the gain controller G_{R} of the gain correction section 26 together and supplies the resultant audio signal to the amplifier 15.

The amplifier 14 amplifies the audio signal supplied from the adder 27 and then supplies the amplified signal to the loudspeaker 31. Like the amplifier 14, the amplifier 15 amplifies the audio signal supplied from the adder 28 and then supplies the amplified signal to the loudspeaker 32.

Although not shown, a D/A converter is provided between the sound field adjustment section 20 and the amplifier 14 for converting the audio signal subjected to digital signal processing into an analog signal and then supplies the analog signal to the loudspeaker 31.

A D/A converter is also provided between the sound field adjustment section 20 and the amplifier 15 for converting the audio signal into an analog signal and then supplies the analog signal to the loudspeaker 32.

The characteristic measurement section 40 is made up of microphones 41 and 42 for collecting playback sounds produced from the loudspeakers 31 and 32 at the listening positions of a listener (almost at the positions of both ears) and supplying sound collection signals, an impulse response measurement section 43 for measuring impulse responses between the loudspeakers 31 and 32 and the microphones 41 and 42, band dividing sections 44 and 45 for extracting low frequency components of the impulse responses measured by the impulse response measurement section 43, and a binaural level difference detection section 46 for calculating the binaural level difference from the low frequency components of the impulse responses input from the band dividing sections 44 and 45. h′_{LL}, h′_{LR}, h′_{RL}, and h′_{RR} indicate the impulse responses in the sound field space.

The band dividing section 44 is implemented as a low-pass filter LPF_{La} having the same characteristic as the low-pass filter LPF_{L} of the band dividing section 21. Likewise, the band dividing section 45 is implemented as a low-pass filter LPF_{Ra} having the same characteristic as the low-pass filter LPF_{R} of the band dividing section 22. The sound collection signals supplied from the microphones 41 and 42 are subjected to impulse response measurement by the impulse response measurement section 43 and then are supplied to the low-pass filters LPF_{La} and LPF_{Ra}.

Although not shown, the sound collection signals supplied from the microphones 41 and 42 are amplified by amplifiers and then are converted into digital signals by A/D converters and the digital signals are supplied to the impulse response measurement section 43.

The binaural level difference detection section 46 calculates the binaural level difference from the low frequency components of the impulse responses input from the band dividing sections 44 and 45 and supplies the binaural level difference to the control section 50.

The control section 50 is made up of a microprocessor and memory. The control section 50 sets the coefficients FilL and FilR of the digital filters FilterL and FilterR of the sound source correction sections 23 and 24 and sets the gains of the gain controllers G_{L} and G_{R} of the gain correction sections 25 and 26 based on the binaural level difference input from the binaural level difference detection section 46.

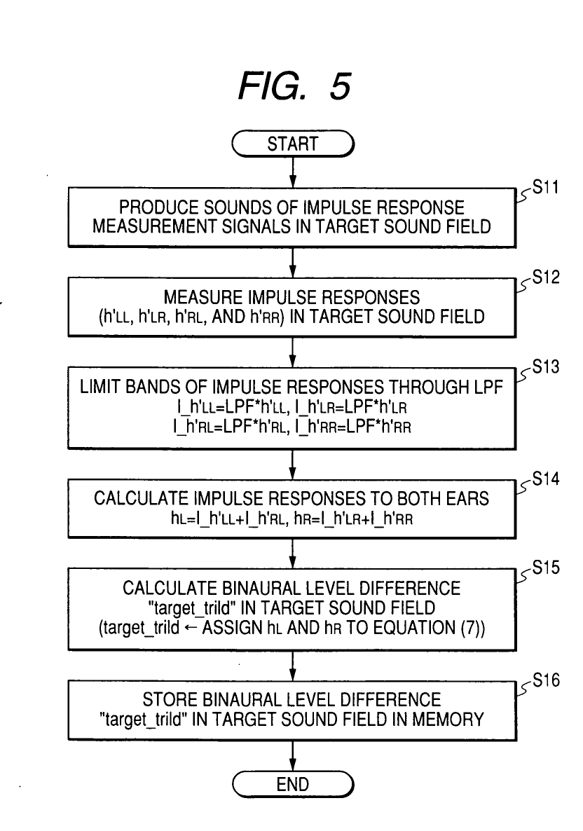

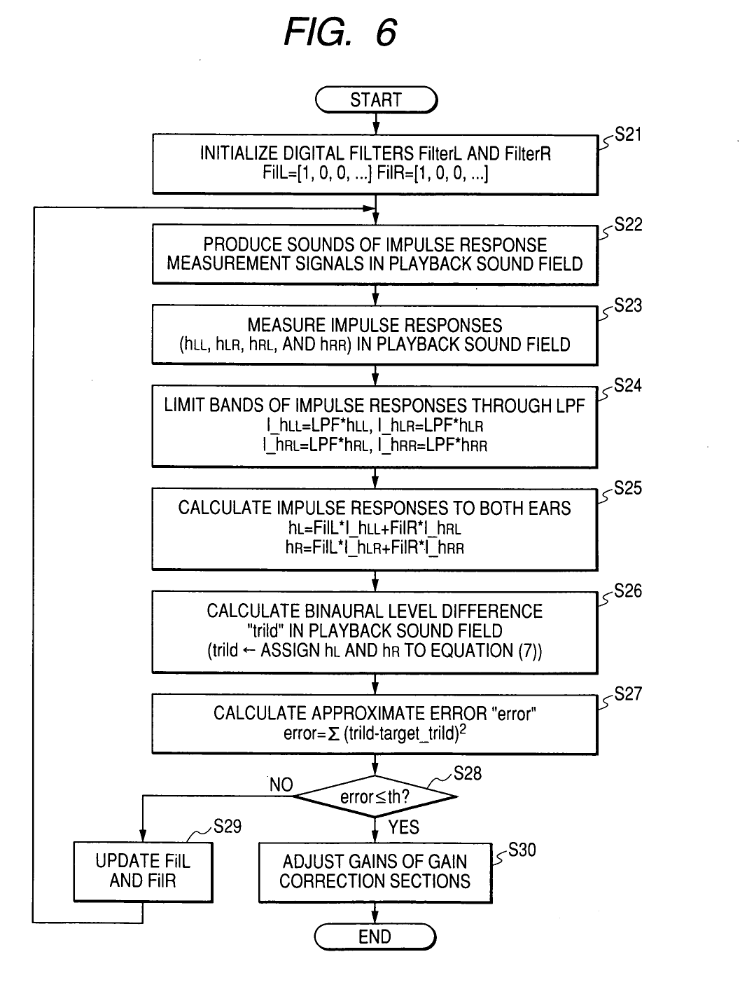

Next, the operation of the sound field control system 10 in FIG. 4 at the sound field adjustment time will be explained with reference to FIGS. 5 and 6. The operation of the sound field adjustment is executed when the user enters an execution command of sound field adjustment with a remote control (not shown), etc.

FIG. 5 is a flowchart to explain the calculation operation of the binaural level difference in the target sound field. The calculation operation of the binaural level difference in the target sound field will be explained with reference to FIG. 5. In FIG. 5, in the target sound field, impulse response measurement signals (M series, TSP, etc.,) are supplied from the sound source 11 and skip the sound field adjustment section 20 by the switches 12 and 13 to the amplifiers 14 and 15 through which sounds of the impulse response measurement signals are produced from the loudspeakers 31 and 32 (step S11). The sounds of the impulse response measurement signals produced from the loudspeakers 31 and 32 are collected by the microphones 41 and 42, and the impulse response measurement section 43 measures the impulse responses (h′_{LL}, h′_{LR}, h′_{RL}, and h′_{RR}) (step S12).

The measured impulse responses have bands limited through the low-pass filters LPF_{La} and LPF_{Ra} of the band dividing sections 44 and 45. The impulse responses with the bands limited l_h′_{LL}=LPF*h′_{LL}, l_h′_{LR}=LPF*h′_{LR}, l_h′_{RL}=LPF*h′_{RL}, and l_h′_{RR}=LPF*h′_{RR} are supplied to the binaural level difference detection section 46 (step S13).

The binaural level difference detection section 46 calculates impulse responses to both ears h_{L}=l_h′_{LL}+l_h′_{RL} and h_{R}=l_h′_{LR}+l_h′_{RR} (step S14)

The binaural level difference detection section 46 assigns the impulse responses to both ears h_{L}=l_h′_{LL}+l_h′_{RL} and h_{R}=l_h′_{LR}+l_h′_{RR} to definition equation (7) of the binaural level difference to calculate the binaural level difference “target_trild” in the target sound field, and supplies the binaural level difference “target_trild” to the control section 50 (step S15). The control section 50 stores the binaural level difference “target_trild” in the target sound field in memory (step S16).

FIG. 6 is a flowchart to explain the setting operation of the coefficients FilL and FilR of the digital filters FilterL and FilterR of the sound source correction section 23. The setting operation of the coefficients FilL and FilR of the digital filters FilterL and FilterR of the sound source correction section 23 will be explained with reference to FIG. 6.

In FIG. 6, first the coefficients FilL and FilR of the digital filters FilterL and FilterR are initialized to the unit impulse (FilL=[1, 0, 0, . . . ], FilR=[1, 0, 0, . . . ]) (step S21). Next, in the playback sound field, impulse response measurement signals (M series, TSP, etc.,) are supplied from the sound source 11 and skip the sound field adjustment section 20 by the switches 12 and 13 to the amplifiers 14 and 15 through which sounds of the impulse response measurement signals are produced from the loudspeakers 31 and 32 (step S22). The sounds of the impulse response measurement signals produced from the loudspeakers 31 and 32 are collected by the microphones 41 and 42, and the impulse response measurement section 43 measures the impulse responses (h_{LL}, h_{LR}, h_{RL}, and h_{RR}) (step S23).

The impulse responses have bands limited through the low-pass filters LPF_{La} and LPF_{Ra} of the band dividing sections 44 and 45, and the impulse responses with the bands limited l_h_{LL}=LPF*h_{LL}, l_h_{LR}=LPF*h_{LR}, l_h_{RL}=LPF*h_{RL}, and l_h_{RR}=LPF*h_{RR} are supplied to the binaural level difference detection section 46 (step S24).

The binaural level difference detection section 46 calculates impulse responses to both ears h_{L}=l_h_{LL}+l_h_{RL} and h_{R}=l_h_{LR}+l_h_{RR} (step S25). The binaural level difference detection section 46 assigns the impulse responses to both ears h_{L}=l_h_{LL}+l_h_{RL} and h_{R}=l_h_{LR}+l_h_{RR} to the definition equation (7) of the binaural level difference to calculate the binaural level difference trild in the playback sound field, and supplies the binaural level difference “trild” to the control section 50 (step S26).

The control section 50 calculates an approximation error between the binaural level difference “target_trild” in the target sound field stored in the memory and the binaural level difference “trild” in the playback sound field, error=Σ(trild−target_trild)² (step S27). The control section 50 determines whether or not the approximation error error≦th (constant) (step S28). If the approximation error error≦th (constant) as the result of the determination (Y at step S28), the control section 50 sets the gains of the gain controllers G_{L} and G_{R} of the gain correction sections 25 and 26 in response to the setup coefficients FilL and FilR of the digital filters FilterL and FilterR (step S30). More specifically, the control section 50 controls the gains of the gain controllers G_{L} and G_{R} of the gain correction sections 25 and 26 to match the levels of the input signals in the medium to high frequency band passed through the high-pass filters HPF_{L} and HPF_{R} of the band dividing sections 21 and 22 with the levels of the input signals in the low frequency band corrected through the digital filters FilterL and FilterR of the sound source correction sections 23 and 24.

On the other hand, if it is not determined that the approximation error error≦th (constant) (N at step S28), the control section 50 updates the coefficients FilL and FilR of the digital filters FilterL and FilterR of the sound source correction sections 23 and 24 so as to lessen the approximation error in a manner as described later (step S29), and then returns to step S22 and repeats the same process until the approximation error error≦th (constant).

The parameters (the coefficients FilL and FilR of the digital filters FilterL and FilterR of the sound source correction sections 23 and 24 and the gains of the gain correction sections 25 and 26) may be once set in the playback sound field unless the playback space and the listening position change.

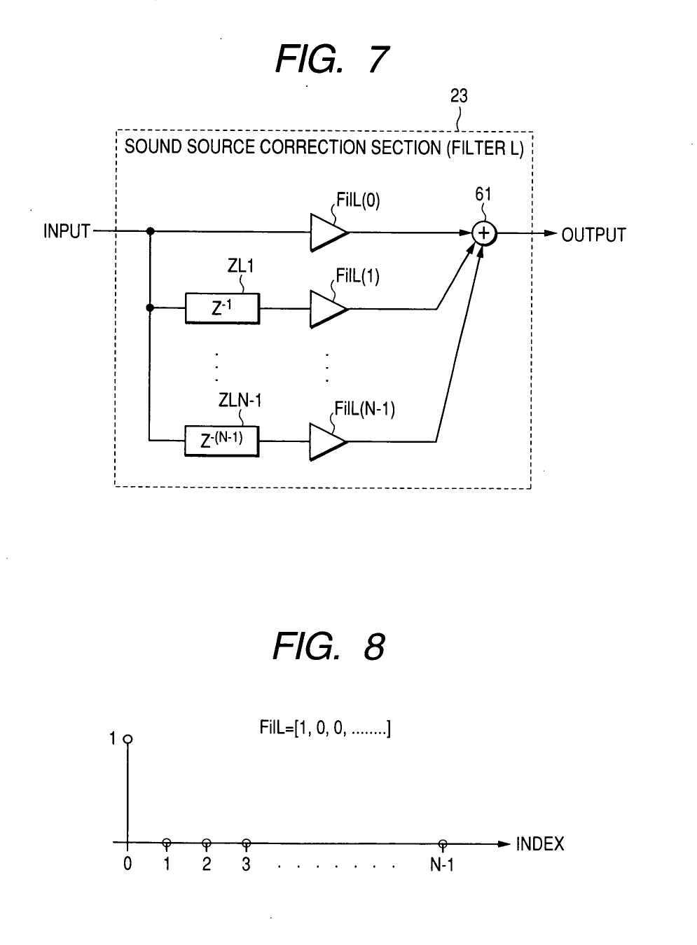

Next, the configuration of the digital filter FilterL, FilterR of the sound source correction section 23, 24 and the setting method of the coefficient FilL, FilR will be explained. FIG. 7 is a drawing to show a configuration example of the digital filter FilterL of the sound source correction section 23 implemented as a FIR filter. The configuration of the digital filter FilterR of the sound source correction section 24 is similar to the configuration of the digital filter FilterL of the sound source correction section 23 and therefore is not shown and will not be explained again.

The digital filter FilterL of the sound source correction section 23 is made up of delay circuits ZL1 to ZLN−1 at N−1 stages for delaying one sample and multipliers FilL (0) to FilL (N−1) at N stages for multiplying outputs of the delay circuits ZL1 to ZLN−1 by a setup coefficient as shown in FIG. 7. The initial value of FilL is [1, 0, 0, . . . ]. FIG. 8 is a drawing to schematically show FilL=[1, 0, 0, . . . ]. Amplitude is 1 only when Index=0; otherwise, 0. The control section 50 sets the coefficient values of FilL (2) to FilL (N) and controls binaural level difference fluctuations in the target sound field and the playback sound field.

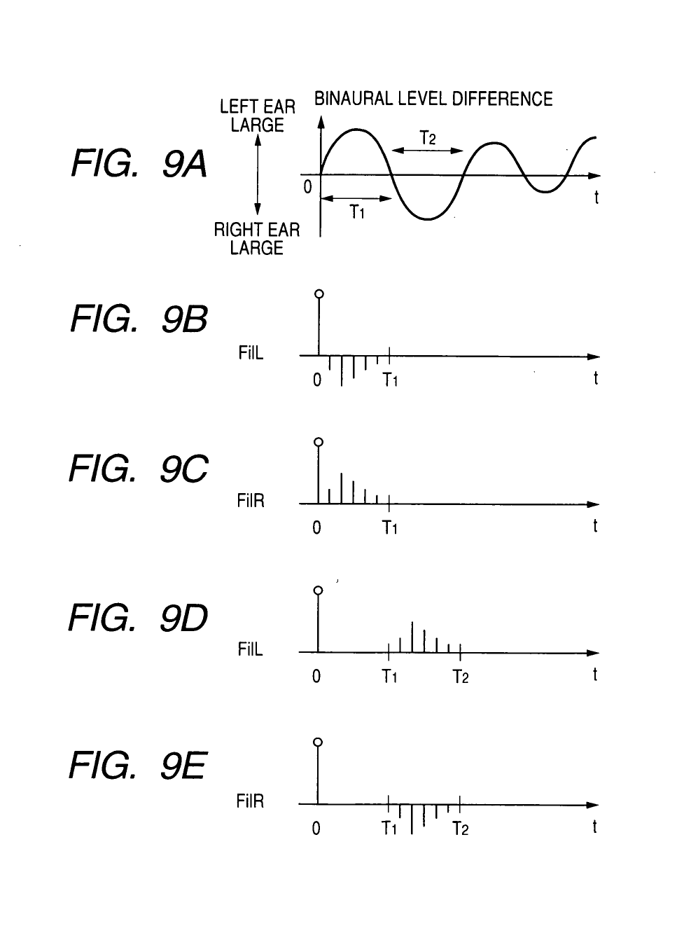

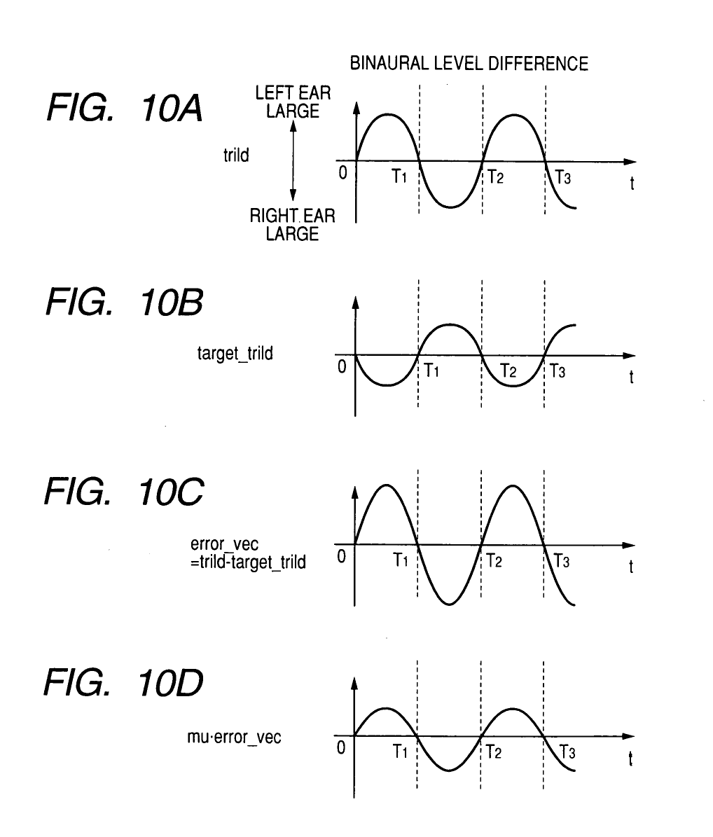

FIGS. 9A to 9E are drawings to describe the control image of the coefficients FilL and FilR of the digital filters FilterL and FilterR (reference drawings). The control image of the coefficients FilL and FilR of the digital filters FilterL and FilterR will be explained for reference. FIG. 9A schematically shows an example of the binaural level difference. The case will be explained where the coefficients FilL and FilR of the digital filters FilterL and FilterR are set so that the binaural level difference becomes 0 at every timing if the binaural level difference is as shown in FIG. 9A.

FIG. 9B schematically shows FilL between 0 and T1. FIG. 9C schematically shows FilR between 0 and T1. FIG. 9D schematically shows FilL between T1 and T2. FIG. 9E schematically shows FilR between T1 and T2.

Energy of the left ear is large between 0 and T1 as shown in FIG. 9A. Thus, FilL and FilR are set so as to cancel energy of the left ear and increase energy of the right ear between 0 and T1, as shown in FIGS. 9B and 9C.

In contrast, energy of the right ear is large between T1 and T2 as shown in FIG. 9A. Thus, FilL and FilR are set so as to cancel energy of the right ear and increase energy of the left ear between T1 and T2, as shown in FIGS. 9D and 9E.

Subsequently, the update method of the coefficients FilL and FilR of the digital filters FilterL and FilterR at step S29 in FIG. 6 will be explained specifically with reference to FIGS. 10A to 10D. FIGS. 10A to 10D are schematic drawings to specifically describe the update method of the coefficients FilL and FilR of the digital filters FilterL and FilterR at step S29 in FIG. 6.

The control section 50 calculates an error vector “error_vec” according to the following equation (8). If the energy of the left ear in the playback sound field is stronger than that in the target sound field, the error vector “error_vec” becomes a positive value; if the energy of the left ear is weaker, the error vector “error_vec” becomes a negative value.
error_{—}vec=trild−target_{—}trild (8)

FIG. 10A shows an example of the binaural level difference in the playback sound field, “trild”. FIG. 10B shows an example of the binaural level difference in the target sound field, “target_trild”. FIG. 10C shows an example of the error vector “error_vec”.

Subsequently, the control section 50 calculates coefficient FilL (index) and FilR (index) according to the following equations (9) and (10) and updates the coefficient FilL (index) and FilR (index):
FilL (index)=FilL (index)−mu·error_{—}vec (index) (9)
where mu: Sufficiently small value
index=rand (1): One random value equal to or more than 2 and equal to or less than the filter length
   FilR (index)=(−1)·FilL (index) (10)
   where indirect sound component is opposite phase to Lch.

FIG. 10D shows “mu·error_vec” provided by adjuting the amplitude of “error_vec” with “mu”. In the example shown in FIG. 10D, “mu·error_vec (index)” is positive with index=0 to T1, for example, and the energy of the left ear is too large in the playback sound field. FilL (index) is lessened according to the equation (9) and FilR (index) is increased according to the equation (10) with index=0 to T1. Accordingly, it is made possible to lessen the energy of the left ear.

In the first example, the data of the binaural level difference “target_trild” in the target sound field may be previously stored in the memory of the control section 50, and only the binaural level difference “trild” in the playback sound field may be calculated, and then the coefficients FilL and FilR of the digital filters FilterL and FilterR may be set so that approximation error error=Σ(trild−target_trild)²<th (constant) in a similar manner to that described above. This eliminates the need for performing the calculation operation of the binaural level difference “target_trild” in the target sound field. In this case, a plurality of target sound fields may be provided and the binaural level difference “target_trild” may be stored for each target sound field. Accordingly, it is made possible to reproduce a plurality of sound fields.

In the first example, the characteristic measurement section 40 calculates the binaural level difference from impulse responses. The characteristic measurement section 40 may measures white noise to calculate the binaural level difference. In this case, the operation of producing sounds from the loudspeakers 31 and 32 and inputting binaural signals from the sound stopping timing may be repeated two or more times and the binaural level difference may be calculated from the ratio between the average of the energy of the left ear <S_{L}²(t)> and the average of the energy of the right ear <S_{R}²(t)> (see equations (5), (6), and (7))

### SECOND EXAMPLE

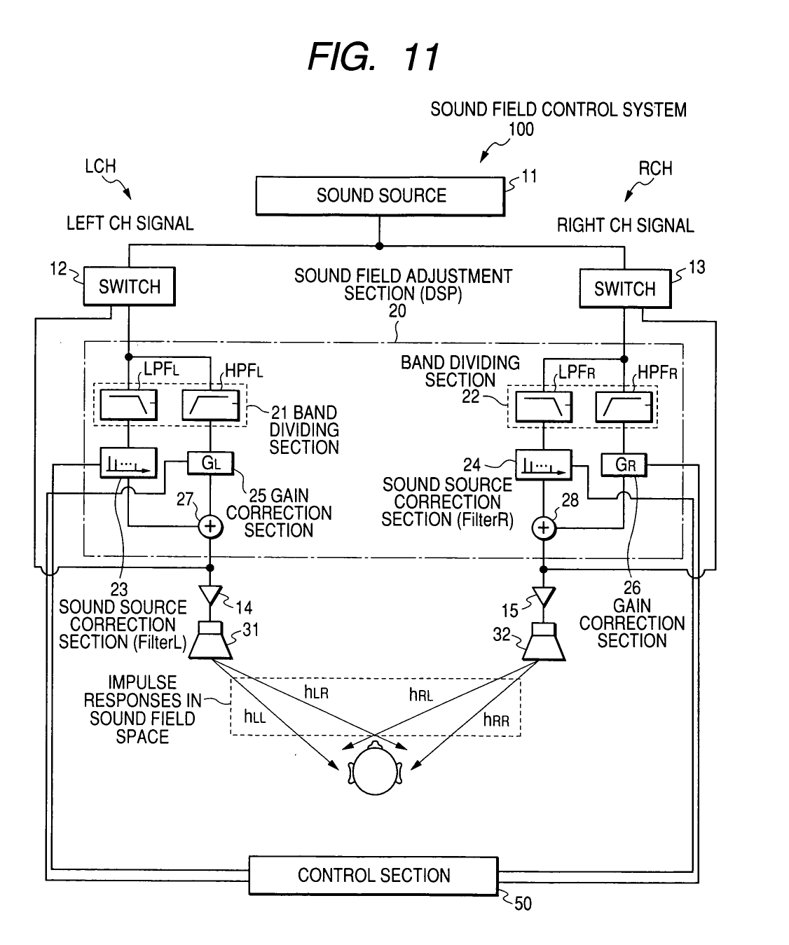

In the first example, the sound field adjustment operation is executed for setting the coefficients FilL and FilR of the digital filters FilterL and FilterR of the sound source correction sections 23 and 24. In a second example, the coefficients FilL and FilR of the digital filters FilterL and FilterR are preset so that approximation error error=Σ(trild−target_trild)²<th (constant). In this case, the playback sound field is a sound field space having a high possibility of being generally used. FIG. 11 is a drawing to show the configuration of a sound field control system 100 according to the second example. Parts similar to or identical with those previously described with reference to FIG. 4 are denoted by the same reference numerals in FIG. 11. As shown in FIG. 11, in the sound field control system 100 of the second example, the characteristic measurement section 40 in FIG. 4 becomes unnecessary, so that it is made possible to provide the sound field control system 100 at low cost.

### THIRD EXAMPLE

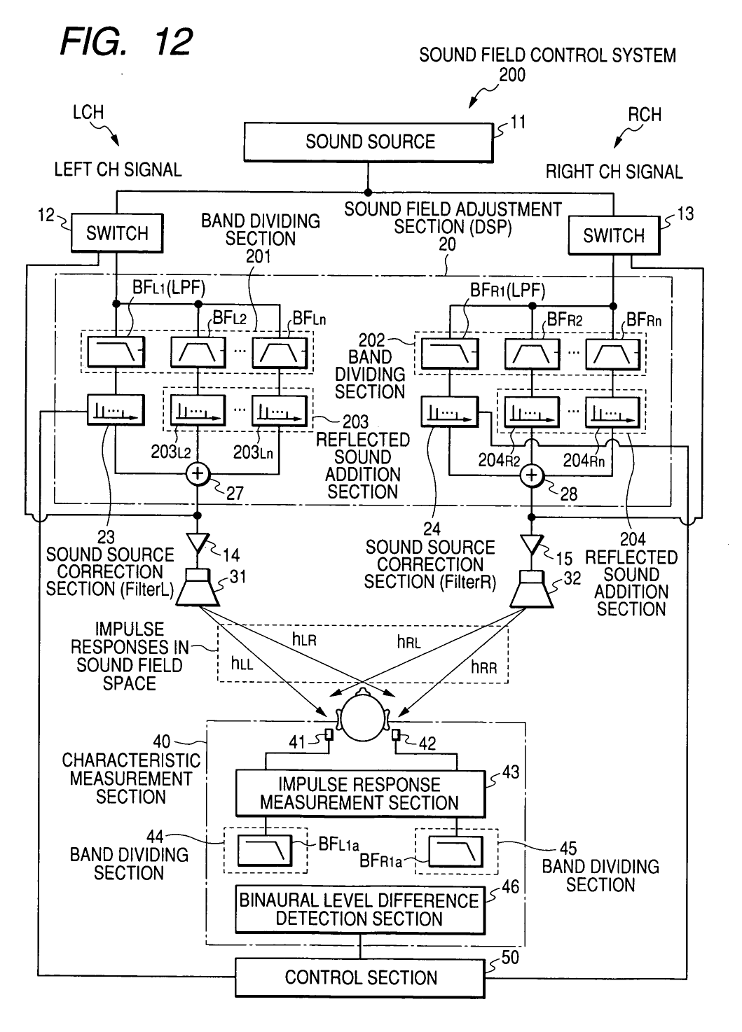

A sound field control system according to a third example makes reflected sound correction to the medium to high frequency component of an input signal in the sound field control system 10 of the first example (see FIG. 4). FIG. 12 is a drawing to show the configuration of a sound field control system 200 according to the third example. Parts similar to or identical with those previously described with reference to FIG. 4 are denoted by the same reference numerals in FIG. 12. The sound field control system 200 of the third example is provided with reflected sound addition sections 203 and 204 in place of the gain correction sections 25 and 26 in the first example. The band dividing section 21, 22 divides an input signal into two frequency bands in the first example, while band dividing section 201, 202 in the third example divides an input signal into n frequency bands (where n≧3). Common parts to those in the first example will not be explained again and only the differences will be explained.

The band dividing section 201 has n band-pass filters BF_{L1} to BF_{Ln} to which an LCH audio signal is supplied through a switch 12. BF_{L1} is LPF (Low-Pass Filters) and allows a signal of 500 Hz or less, for example, to pass through and BF_{L2} to BF_{Ln} are BPFs (Band-Pass Filters) and allow a signal of 500 Hz or more, for example, to pass through. The band-pass filters BF_{L1} to BF_{Ln} are assigned to n bands into which the whole audio frequency band is divide in a one-to-one correspondence. The band-pass filters BF_{L1} to BF_{Ln} can be implemented as n secondary IIR filters. BF_{L1} supplies the low frequency component of the LCH audio signal to a sound source correction section 23, and the band-pass filters BF_{L2} to BF_{Ln} supply the medium to high frequency component of the LCH audio signal to a gain correction section 25.

Like the band dividing section 201, the band dividing section 202 is made up of n band-pass filters BF_{R1} to BF_{Rn} to which an RCH audio signal is supplied through a switch 13. BF_{R1} is LPF and allows a signal of 500 Hz or less, for example, to pass through and BF_{R2} to BF_{Rn} are BPFs and allow a signal of 500 Hz or more, for example, to pass through. The band-pass filters BF_{R1} to BF_{Rn} are assigned to n bands into which the whole audio frequency band is divide in a one-to-one correspondence. The band-pass filters BF_{R1} to BF_{Rn} are set to the same divide bands as the band-pass filters BF_{L1} to BF_{Ln}. BFR1 supplies the low frequency component of the RCH audio signal to a sound source correction section 24, and the band-pass filters BF_{R2} to BF_{Rn} supply the medium to high frequency component of the RCH audio signal to a gain correction section 26.

The reflected sound addition section 203 includes n−1 reflected sound addition filters 203_{L2} to 203_{Ln}. Each of the reflected sound addition filters 203_{L2} to 203_{Ln} has a coefficient set based on the difference between the reflected sound evaluation value indicating the spatial impression of the playback sound field and the reflected sound evaluation value indicating the spatial impression of the target sound field so that the reflected sound evaluation values become equal to each other. The reflected sound addition filters 203_{L2} to 203_{Ln} make reflected sound correction to the audio signals of the medium to high frequency components input from the band-pass filters BF_{L2} to BF_{Ln}.

Like the reflected sound addition section 203, the reflected sound addition section 204 includes n−1 reflected sound addition filters 204_{R2} to 204_{Rn}. Each of the reflected sound addition filters 204_{R2} to 204_{Rn} has a coefficient set based on the difference between the reflected sound evaluation value indicating the spatial impression of the playback sound field and the reflected sound evaluation value indicating the spatial impression of the target sound field so that the reflected sound evaluation values become equal to each other. The reflected sound addition filters 204_{R2} to 204_{Rn} make reflected sound correction to the audio signals of the medium to high frequency components input from the band-pass filters BF_{R2} to BF_{Rn}. The reflected sound corrections of the reflected sound addition sections 203 and 204 are explained in detail in Japanese Patent Application 2003-067814 and 2002-053483 being filed by the assignee.

An adder 27 adds the audio signal supplied from the sound source correction section 23 and the n−1 audio signals supplied from the reflected sound addition filters 203_{L2} to 203_{Ln} of the reflected sound addition section 203 together and supplies the resultant audio signal to an amplifier 14.

Like the adder 27, an adder 28 adds the audio signal supplied from the sound source correction section 24 and the n−1 audio signals supplied from the reflected sound addition filters 204_{R2} to 204_{Rn} of the reflected sound addition section 204 together and supplies the resultant audio signal to an amplifier 15.

According to the third example, binaural correction is made to the low frequency component and reflected sound correction is made to the medium to high frequency component, so that the reflected sound in the target sound field can be reproduced and it is made possible to reproduce the target sound field with high accuracy.

In the third example, the reflected sound addition sections 203 and 204 for controlling the reflected sound are provided, but an equalizing section may be provided in place of the reflected sound addition section 203, 204 in response to the use of the system.

### FOURTH EXAMPLE

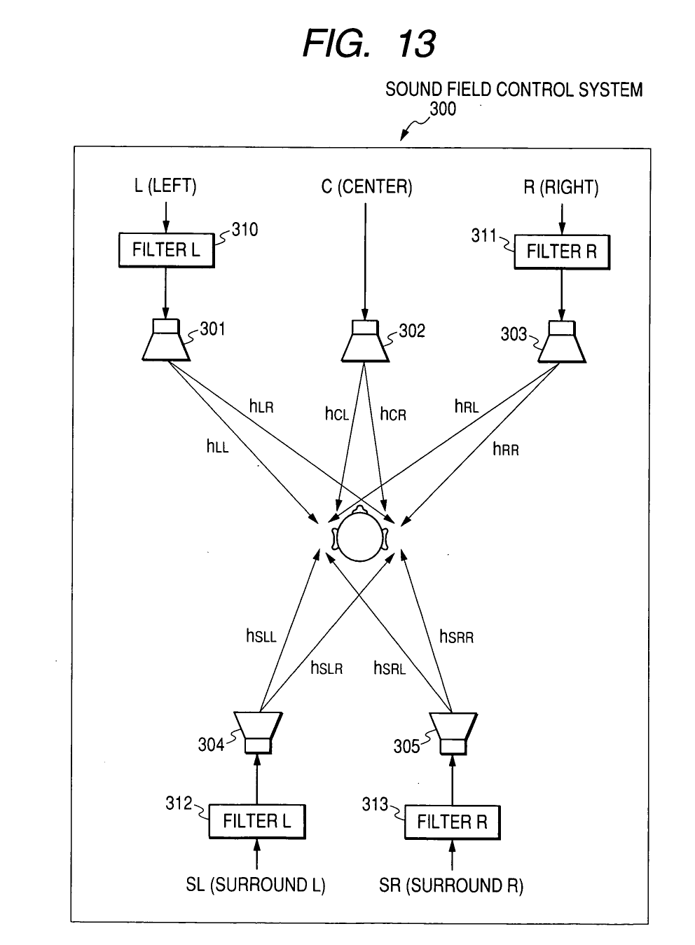

In the first example, the sound field control system to handle the 2CH source is described. In contrast, in a fourth example, a sound field control system to handle a multi-channel source of 5.1 channels will be explained. FIG. 13 is a drawing to schematically show the sound field space of a sound field control system 300 according to the fourth example. FIG. 13 does not show sound source, amplifiers, band dividing sections, characteristic measurement section, or control section.

As shown in FIG. 13, for 5.1 CH, three loudspeakers 301, 302, and 303 are placed as front loudspeakers, two loudspeakers 304 and 305 are placed as rear loudspeakers, and a subwoofer (not shown) is placed in a corner of the room. The subwoofer does not always woof and supplies only an audio signal of a very low frequency component and therefore only the five loudspeakers 301 to 305 are considered.

Digital filters FilterL 310 and FilterL 312 for controlling the left ear are placed in front of the left-direction loudspeakers (L and SL) 301 and 304, and digital filters FilterR 311 and FilterR 313 for controlling the right ear are placed in front of the right-direction loudspeakers (R and SR) 303 and 305. The center loudspeaker 302 is set through. The same coefficient FilL is set in the digital filters FilterL 310 and FilterL 312, and the same coefficient FilR is set in the digital filters FilterR 311 and FilterR 313.

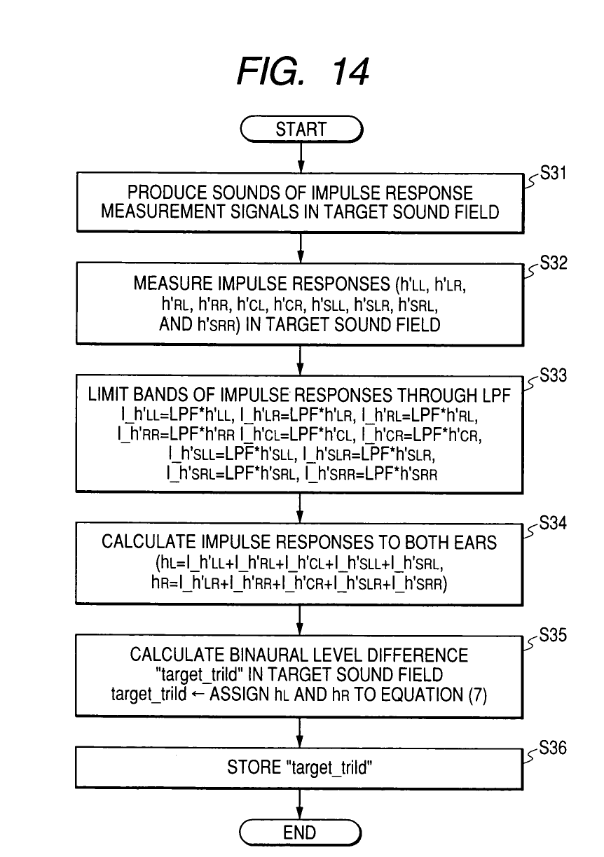

FIG. 14 is a flowchart to explain the calculation operation of the binaural level difference in the target sound field in the sound field control system 300. The calculation operation of the binaural level difference in the target sound field in the sound field control system 300 will be explained with reference to FIG. 14.

In FIG. 14, first, in the target sound field, impulse response measurement signals (M series, TSP, etc.,) are supplied from a sound source (not shown) and sounds of the impulse response measurement signals are produced from the five loudspeakers 301 to 305 through amplifiers (not shown) (step S31). The sounds of the impulse response measurement signals produced from the five loudspeakers 301 to 305 are collected by microphones (not shown), and an impulse response measurement section (not shown) measures impulse responses (h′_{LL}, h′_{LR}, h′_{RL}, h′_{RR}, h′_{CL}, h′_{CR}, h′_{SLL}, h′_{SLR}, h′_{SRL}, and h′_{SRR}) (step S32)

The impulse responses have bands limited through LPFs (not shown) and then the impulse responses with the bands limited (l_h′_{LL}=LPF*h′_{LL}, l_h′_{LR}=LPF*h′_{LR}, l_h′_{RL}=LPF*h′_{RL}, l_h′_{RR}=LPF*h′_{RR}, l_h′_{CL}=LPF*h′_{CL}, l_h′_{CR}=LPF*h′_{CR}, l_h′_{SLL}=LPF*h′_{SLL}, l_h′_{SLR}=LPF*h′_{SLR}, l_h′_{SRL}=LPF*h′_{SRL}, l_h′_{SRL}=LPF*h′_{SRL}, and l_h′_{SRR}=LPF*h′_{SRR}) are supplied to a binaural level difference detection section (not shown) (step S33).

The binaural level difference detection section (not shown) calculates impulse responses to both ears h_{L}=l_h′_{LL}+l_h′_{RL}+l_h′_{CL}+l_h′_{SLL}+l_h′_{SRL}, and h_{R}=l_h′_{LR}+l_h′_{RR}+l_h′_{CR}+l_h′_{SLR}+l_h′_{SRR} (step S34)

The binaural level difference detection section (not shown) assigns the impulse responses to both ears h_{L}=l_h′_{LL}+l_h′_{RL}+l_h′_{CL}+l_h′_{SLL}+l_h′_{SRL}, and h_{R}=l_h′_{LR}+l_h′_{RR}+l_h′_{CR}+l_h′_{SLR}+l_h′_{SRR} to the definition equation (7) of the binaural level difference to calculate the binaural level difference “target_trild” in the target sound field, and supplies the binaural level difference “target_trild” to a control section (not shown) (step S35). The control section (not shown) stores the binaural level difference “target_trild” in the target sound field in memory (step S36).

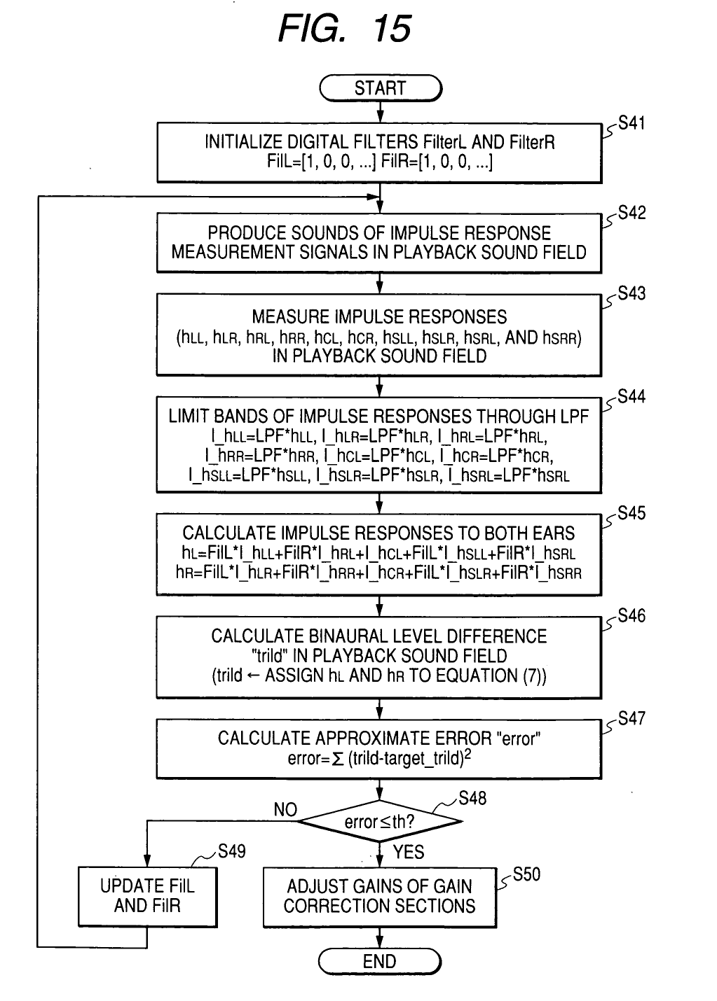

FIG. 15 is a flowchart to explain the setting operation of the coefficients FilL and FilR of the digital filters FilterL 310, FilterL 312, FilterR 311, and FilterR 313. The setting operation of the coefficients FilL and FilR of the digital filters FilterL 310, FilterL 312, FilterR 311, and FilterR 313 will be explained with reference to FIG. 15.

In FIG. 15, first the coefficients FilL and FilR of the digital filters FilterL 310, FilterL 312, FilterR 311, and FilterR 313 are initialized to the unit impulse (FilL=[1, 0, 0, . . . ], FilR=[1, 0, 0, . . . ]) (step S41)). Next, in the playback sound field, impulse response measurement signals (M series, TSP, etc.,) are supplied from the sound source (not shown) and sounds of the impulse response measurement signals are produced from the five loudspeakers 301 to 305 through the amplifiers (not shown) (step S42). The sounds of the impulse response measurement signals produced from the five loudspeakers 301 to 305 are collected by microphones (not shown), and the impulse response measurement section (not shown) measures the impulse responses (h_{LL}, h_{LR}, h_{RL}, h_{RR}, h_{CL}, h_{CR}, h_{SLL}, h_{SLR}, h_{SRL}, and h_{SRR}) (step S43)

The impulse responses have bands limited through LPFs (not shown) and the impulse responses with the bands limited (l_h_{LL}=LPF*h_{LL}, l_h_{LR}=LPF*h_{LR}, l_h_{RL}=LPF*h_{RL}, l_h_{RR}=LPF*h_{RR}, l_h_{CL}=LPF*h_{CL}, l_h_{CR}=LPF*h_{CR}, l_h_{SLL}=LPF*h_{SLL}, l_h_{SLR}=LPF*h_{SLR}, l_h_{SRL}=LPF*h_{SRL}, and l_h_{SRR}=LPF*h_{SRR}) are supplied to the binaural level difference detection section (not shown) (step S44).

The binaural level difference detection section (not shown) calculates impulse responses to both ears h_{L}=FilL*l_h_{LL}+FilR*l_h_{RL}+l_h_{CL}+FilL*l_h_{SLL}+FilR*l_h_{SRL}, and h_{R}=FilL*l_h_{LR}+FilR*l_h_{RR}+l_h_{CR}+FilL*l_h_{SLR}+FilR*l_h_{SRR} (step S45).

The binaural level difference detection section (not shown) assigns the impulse responses to both ears (h_{L}=Fi1L*l_h_{LL}+FilR*l_h_{RL}+l_h_{CL}+FilL*l_h_{SLL}+FilR*l_h_{SRL}, and h_{R}=FilL*l_h_{LR}+FilR*l_h_{RR}+l_h_{CR}+FilL*l_h_{SLR}+FilR*l_h_{SRR}) to the definition equation (7) of the binaural level difference to calculate the binaural level difference “trild” in the playback sound field, and supplies the binaural level difference “trild” to the control section (not shown) (step S46).

The control section (not shown) calculates an approximation error between the binaural level difference “target_trild” in the target sound field stored in the memory and the binaural level difference “trild” in the playback sound field, error=Σ(trild−target_trild)² (step S47) The control section (not shown) determines whether or not the approximation error error≦th (constant) (step S48). If the approximation error error≦th (constant) as the result of the determination (Y at step S48), the control section (not shown) sets the gains of gain correction sections (not shown) in response to the setup coefficients FilL and FilR (step S50).

On the other hand, if it is not determined that the approximation error error≦th (constant) (N at step S48), the control section (not shown) updates the coefficients FilL and FilR of the digital filters FilterL 310, FilterL 312, FilterR 311, and FilterR 313 by a similar method to that in the first example and then returns to step S42 and repeats the same process until the approximation error error≦th (constant).

According to the fourth example, for the multi-channel source of 5.1 channels, the sound source in the playback sound field can also be corrected so as to provide the reproduction characteristic of the target sound field based on the binaural level difference. Here, the multi-channel source of 5.1 channels has been described, but the invention is not limited to it. The invention can also be applied if the number and placement of loudspeakers vary depending on the source format. That is, both ears are controlled through the two filters FilterL and FilterR and FilterL is used for the loudspeaker in the left direction and FilterR is used for the loudspeaker in the right direction, whereby other multi-channel sources can be handled.

1. A sound field control system, which generates a target sound field for an input signal, comprising:
a band dividing section for dividing the input signal into a plurality of frequency bands; and
a sound source correction section for making correction to the input signal of a first frequency band provided by said band dividing section so as to eliminate an error between a first binaural level difference expressed as a ratio between ensemble mean values of signals to at least two detection sections in the target sound field and a second binaural level difference expressed as a ratio between ensemble mean values of signals to said two detection sections in a playback sound field.

2. The sound field control system according to claim 1, wherein said sound source correction section makes correction to the input signal of the first frequency band so that the error between the first binaural level difference in the target sound field and the second binaural level difference in the playback sound field is equal to or less than a predetermined value.

3. The sound field control system according to claim 1, further comprising:
a gain adjustment section for making gain adjustment to the input signal of a second frequency band provided by said band dividing section; and
a sound source combining section for recombining the input signal of the first frequency band corrected by said sound source correction section and the input signal of the second frequency band subjected to the gain adjustment by said gain adjustment section.

4. The sound field control system according to claim 1, further comprising:
a reflected sound addition section for making reflected sound correction to the input signal of the second frequency band provided by said band dividing section; and
a sound source combining section for recombining the input signal of the first frequency band corrected by said sound source correction section and the input signal of the second frequency band subjected to the reflected sound correction by said reflected sound addition section.

5. The sound field control system according to claim 3 or 5, wherein the first frequency band is lower than the second frequency band.

6. The sound field control system according to claim 1, further comprising:
a characteristic measurement section for calculating the second binaural level difference in the playback sound field.

7. The sound field control system according to claim 6,
wherein said characteristic measurement section measures an impulse response in the playback sound field to calculate the second binaural level difference in the playback sound field based on the measured impulse response.

8. The sound field control system according to claim 6,
wherein said characteristic measurement section measures white noise in the playback sound field to calculate the second binaural level difference in the playback sound field based on the measured white noise.

9. The sound field control system according to claim 1,
wherein said sound source correction section is implemented as a digital filter, and
said sound field control system further comprising a control section for setting a coefficient of said digital filter so that the error between the first binaural level difference in the target sound field and the second binaural level difference in the playback sound field is equal to or less than the predetermined value.

10. The sound field control system according to claim 1, wherein the input signal is a signal of a source having two or more channels.

11. A sound field control method of generating a target sound field for an input signal, comprising the steps of:
dividing the input signal into a plurality of frequency bands; and
making correction to the input signal of a divided frequency band so as to eliminate an error between a binaural level difference expressed as a ratio between ensemble mean values of signals to at least two detection sections in the target sound field and a binaural level difference expressed as a ratio between ensemble mean values of signals to said two detection sections in a playback sound field.
